(19) United States
(12) Patent Application Publication
(10) Pub. No.: US 2013/0321151 A1
(43) Pub. Date: Dec. 5, 2013

(54) Alarmed Intruder Barrier

(71) Applicant: Marius de Wet de Villiers, Stellenbosch (ZA)

(72) Inventor: Marius de Wet de Villiers, Stellenbosch (ZA)

(21) Appl. No.: 13/985,529

(22) PCT Filed: Nov. 30, 2011
(86) PCT No.: PCT/IB2011/002875

§ 371 Date: Aug. 14, 2013

(30) Foreign Application Priority Data
Mar. 10, 2011 (ZA) 2011/01834

(51) Int. Cl. G08B 13/12

(52) U.S. Cl. CPC G08B 13/12
USPC 340/561

(57) ABSTRACT

An intruder barrier is provided that includes multiple generally parallel transparent slats acting as burglar bars with at least some, and preferably all, of the transparent slats having associated therewith a conductive path extending at least from a first end region of a slat to a second end region thereof. The conductive path is capable of conducting electricity or electromagnetic radiation along the length of the slat and is associated with an output to an alarm system that may be configured to trigger an alarm when the conductive characteristic of a slat is terminated by virtue of the slat being at least partially severed, broken, or removed from its operative position. Typically the transparent slats are secured to a fixed surrounding frame of an opening window. The invention in a further embodiment includes transparent slats for use in such an intruder barrier. The invention in a further provides embodiment includes a laterally collapsible latticed intruder barrier comprising multiple transparent slats interconnected with each other and having such conductive paths.

### FIELD OF THE INVENTION

This invention relates to an alarmed intruder barrier of the general type that may be used in relation to access openings such as windows and doors that provide access to premises including laterally collapsible latticed intruder barriers commonly used in association with doorways.

### BACKGROUND TO THE INVENTION

Protecting premises against unauthorised entry by criminals is commonly achieved using fixed metal (usually steel or aluminium) burglar bars secured over windows as well as laterally collapsible latticed intruder barriers over doorways.

As regards windows, the windows themselves are commonly alarmed by way of magnetic switches that detect when a window is opened by virtue of the switch changing from an open to a close condition or vice versa, according to the type of alarm system that is employed.

The existing common arrangement has at least two main disadvantages, namely, the metal burglar bars are generally unsightly and impair the view through the window, and secondly there is generally no means of warning if a burger bar has been cut or is otherwise tampered with whilst a window has been left open with the alarm inoperative by virtue of it being switched off to allow the window to be opened.

U.S. Pat. No. 3,947,837 has suggested a glass panel having an electrical conductor embedded therein such that an alarm can be triggered if the glass is broken. However, such an arrangement offers no protection whatsoever whilst the relevant window is left open and metal burglar bars would nevertheless need to be employed if a window is to be left open.

Applicant is unaware of any burglar alarms that have been integrated into a laterally collapsible latticed intruder barrier that is also unsightly and impairs the view through a doorway or window being protected.

### SUMMARY OF THE INVENTION

In accordance with one aspect of this invention there is provided an intruder barrier characterised in that it comprises multiple generally parallel transparent slats acting as burglar bars and wherein at least some of the transparent slats have associated therewith a conductive path extending at least from a first end region of a slat to a second end region thereof wherein the conductive path is capable of conducting electricity or electromagnetic radiation along the length of a slat and wherein the ends of the conductive path are associated with an output to an alarm system that may be configured to trigger an alarm when the conductive characteristic of a slat is terminated by virtue of the slat being at least partially severed, broken, or removed from its operative position.

Further features of this aspect of the invention provide for the transparent slats to be secured to a fixed surrounding frame of an opening window; for all of the transparent slats to have with a conductive path associated therewith; for the conductive paths of the slats to be connected in series with each other and with an output to an alarm system; for the conductive path to be an electrically conductive path assuming the form of a wire; for the ends of each slat to be secured to a fixed frame by way of custom-made fittings secured to the surrounding frame, in use; and for the construction of each of the transparent slats to be substantially as defined in more detail below.

In accordance with a second aspect of the invention there is provided a transparent slat for use as a slat in an intruder barrier as defined above, the slat having a conductor applied to the slat so as to extend at least from a first end region to a second end region and wherein the conductor is capable of conducting electricity or electromagnetic radiation along its length, the conductor being either embedded within the material of which the slat is made or being secured thereto.

Further features of the second aspect of the invention provide for the conductor to be selected from an electrically conductive wire that is optionally located in a groove in a longitudinal edge of the slat, a conductive stripe applied to the surface of the slat and an optical fibre conductor; for the conductor to extend from a first end region of the slat to a second end region of the slat and back again to the first end region; and for a portion of the conductor where it is a separate item to extend away from the slat to form a loop that can be anchored to a frame or fitting secured to a frame.

In accordance with a third aspect of the invention there is provided a laterally collapsible latticed intruder barrier comprising multiple transparent slats interconnected with each other and wherein at least some of the transparent slats are provided with a conductive path as defined above.

In order that the above and other features of the invention may be more fully understood, various different embodiments of the invention will now be described with reference to the accompanying drawings.

### BRIEF DESCRIPTION OF THE DRAWINGS

In the drawings:

FIG. 1 is an elevation of a window fitted with an intrusion barrier according to the invention;

FIG. 2 is an enlarged elevation of the end regions of one slat showing a fitting whereby the slat is attached to a window frame with its cover partially broken away in each case;

FIG. 3 is an isometric view of one end of a slat showing how the conductors are attached thereto;

FIG. 4 is a schematic elevation showing one arrangement of transparent slats connected into an alarm system;

FIG. 5 is a similar elevation showing an alternative arrangement of transparent slats connected into an alarm system;

FIG. 6 is a view similar to FIG. 3 showing one alternative arrangement of conductor applied to a slat;

FIG. 7 is a view similar to FIG. 3 showing a second alternative arrangement of conductor within a slat;

FIG. 8 is a view similar to FIG. 3 showing a third alternative arrangement of conductor within a slat;

FIG. 9 is a schematic elevation similar to FIG. 4 of a further arrangement of transparent slats connected into an alarm system;

FIG. 10 is a schematic elevation of a laterally collapsible lattice intruder barrier; and,

FIG. 11 is an elevation illustrating one form of slat and the way in which it can have its length trimmed to provide a desired length of slat.

### DETAILED DESCRIPTION WITH REFERENCE TO THE DRAWINGS

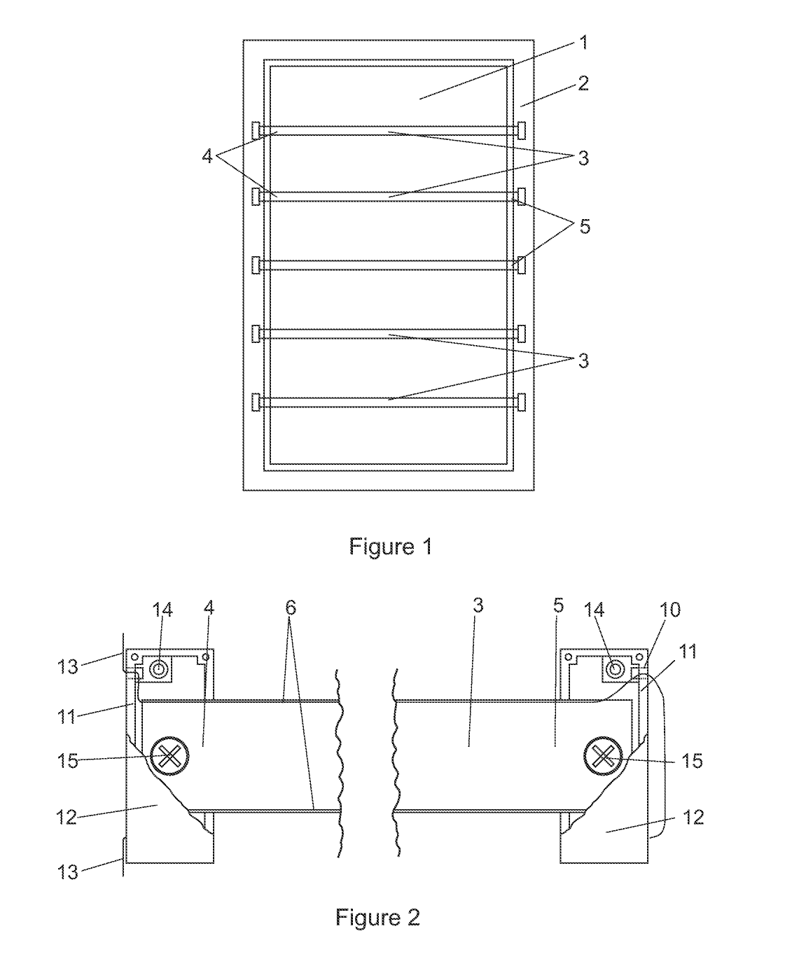

In the embodiment of the invention illustrated in FIG. 1, an intruder barrier according to the invention is permanently fitted over an opening window (1) having a fixed surrounding window frame (2). The intruder barrier comprises a series of vertically spaced, generally parallel transparent slats (3) that act as burglar bars. The slats are preferably totally colourless so that they will obscure vision only to an extremely small extent, if at all. They are made of an extremely strong and tough plastics material such as a suitable polycarbonate. The spacing between the parallel slats is selected using similar constraints as are used in the construction of opaque metal burglar bars and the spacing is typically between about 100 and 150 mm. The width of the slats is conveniently about 30 mm although any appropriate width may be selected.

Each of the transparent slats has associated therewith a conductive path extending from a first end region (4) of the slat to a second end region (5) thereof and back again to the first end region. The conductor (6) is, in this instance, electrically conductive and is embedded within an adhesive sealant (7) in grooves (8) in the two longitudinal edges of the slat. The edges of the slats are suitably rounded in order to obviate any inadvertent injury that may be inflicted by a sharp edge.

A portion of the conductor extends away from the slat at the second end thereof to form a loop (9) that can be anchored to a frame or fitting secured to a frame by means of a faster.

The ends of each slat are, in this embodiment of the invention, secured to the fixed frame by way of a custom-made fitting comprising a base (11) secured, in use, to the surrounding frame and a cover (12) that clips on to the base. The base is arranged such that connecting wires (13) communicating with the conductors associated with the slats can pass through apertures in the side wall of the base so as to be led to a suitable alarm system that is further described below. A slat can therefore not be removed from the installed position without removing the fittings as well. Each of the bases of the fittings has two attachment lugs (14) for accommodating screws or other fasteners such as pop rivets, as may be appropriate, passing into the fixed frame.

It is within the scope of this invention that the ends of the slats are simply held captive by the custom-made fittings. However, it is preferred that the ends of the slats are also secured to the frame directly by way of suitable fasteners (15) such as the Philips screws illustrated. Of course with a fixed frame of aluminium, pop rivets or other suitable fastness could also be used.

It will be understood that the loop (9) of each conductor is also secured to the fixed frame by way of one or more of the fasteners so that the conductor will be broken if a slat is removed from its fitting.

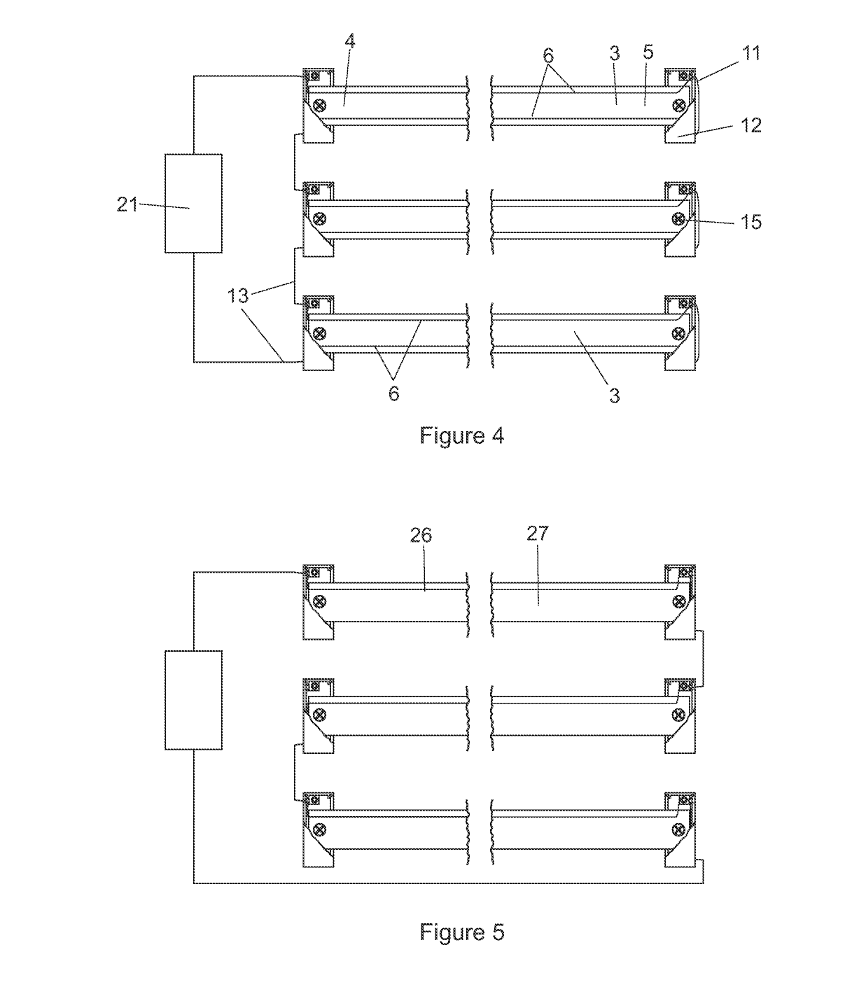

The conductors of the series of slats, three of which are shown in FIG. 4, are electrically connected in series with each other and with an output to an alarm system (21). The alarm system is configured to trigger an alarm when the conductive characteristic of a slat ceases to be recognised by the series circuit by virtue of the fact that the relevant slat has been at severed to an extent that the conductor has been severed; a slat has been broken; or a slat has been removed from its operative position.

In operation, therefore, the opening window can be left open and the relevant alarm system can be left in and “on” condition. This being so, if there should be any tampering with the transparent slats in the manner indicated above, the alarm will be triggered.

The intruder barrier provided by the invention therefore provides an extremely unobtrusive, but highly effective, intruder barrier that enables an alarm to be left in and on condition whilst a window is open.

Numerous variations may be made to the embodiment of the invention described above without departing from the scope hereof.

In particular, and as illustrated in FIG. 5, the conductors (26) may only extend from a first end region to a second end region of a slat (27) and not back to the first end region again. In such an instance of the conductors may still be connected in series with each other, as shown in FIG. 5.

The way in which a conductor is attached to a slat may also be varied widely. Thus, as illustrated in FIG. 6, the conductive paths could be in the form of electrically conductive stripes (31) that may be printed onto the surface of the slat (32) or otherwise applied using adhesive.

Also, as illustrated in FIG. 7, conductors (35) could be moulded into the interior of the plastic material of the slats (36) such as in an extrusion process. FIG. 8 shows a similar arrangement with a single conductor (38).

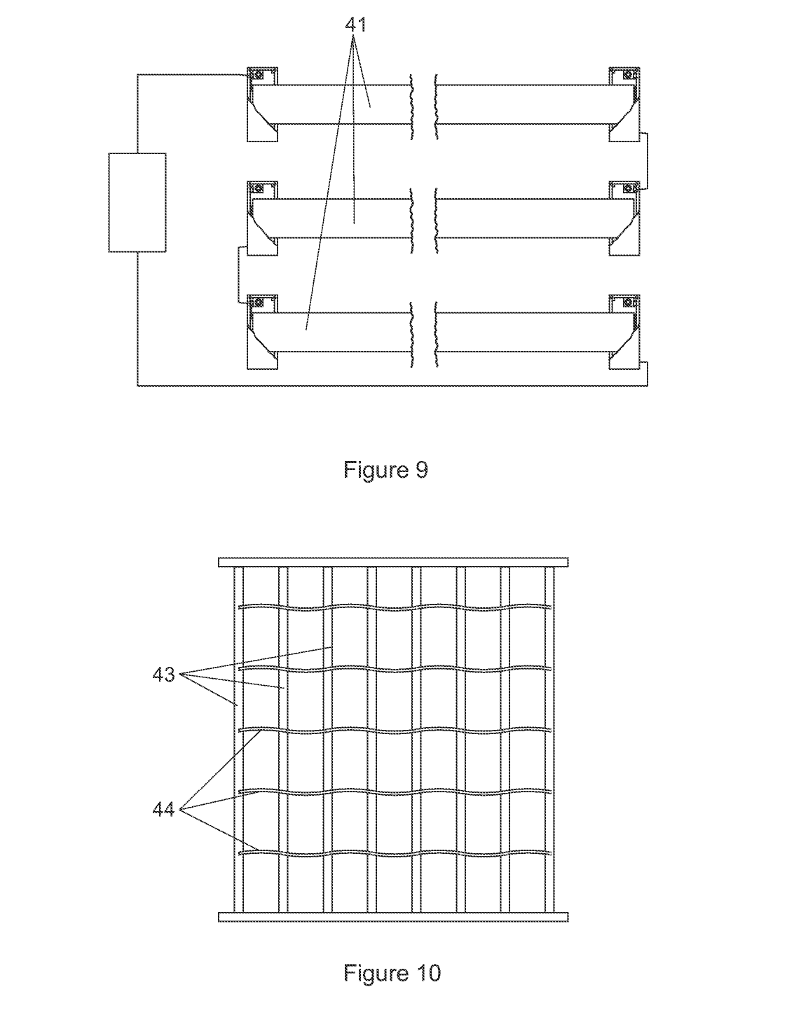

Indeed, it is also within the scope of this invention, an as illustrated in FIG. 9, that the slat (41) itself could serve as the conductive path for suitable electromagnetic radiation such as infrared radiation or the like that could be passed through the slat itself from one end to the other. In such an arrangement, the slats could be arranged in a series thereof so that any break in continuity associated with any one of the slats will give rise to a triggering of the alarm.

Of course, it is also within the scope of this invention that the conductive path of each transparent slat could be separately connected into an alarm system.

The arrangement of slats can also be varied widely. Included within the scope of the invention is an intrusion barrier in the form of a laterally collapsible latticed intrusion barrier having multiple generally vertical transparent slats (43), as shown in FIG. 10. In such an instance conductors can be applied to the slats in any of the manners mentioned above. FIG. 10 also illustrates an arrangement in which the transparent slats are not secured directly to a surrounding frame by means of fasteners.

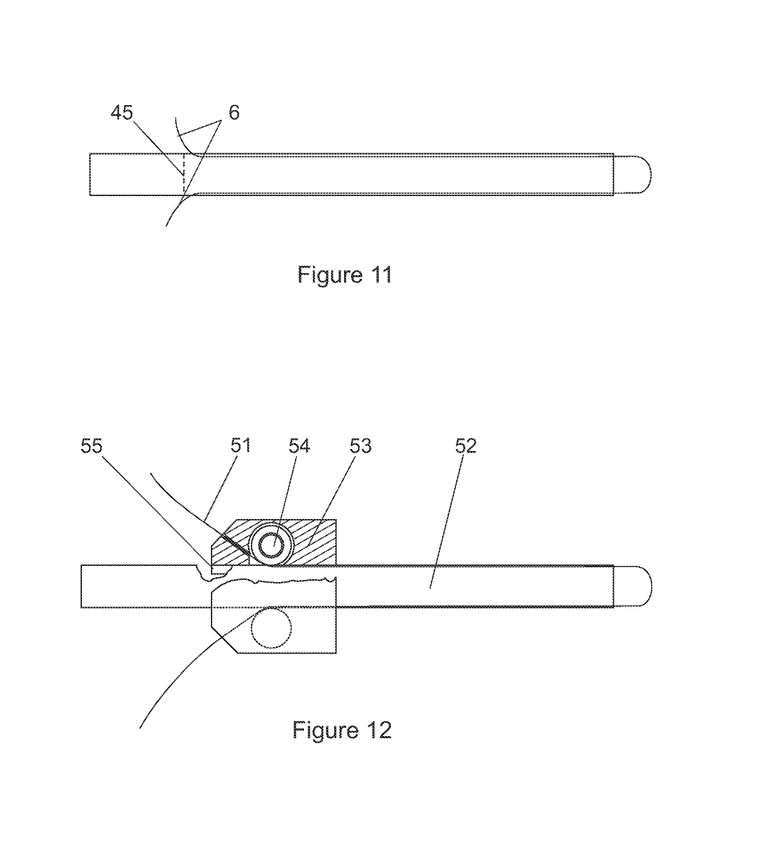

It is to be noted also that the invention is suitable for ease of installation and that the slats will be supplied in suitable standard lengths. A standard length, as illustrated in FIG. 11, can generally be arranged so that a portion of the length can be trimmed off at an appropriate position such as is indicated by the dotted line (45), in which instance the conductors are simply arranged accordingly, at least in appropriate circumstances.

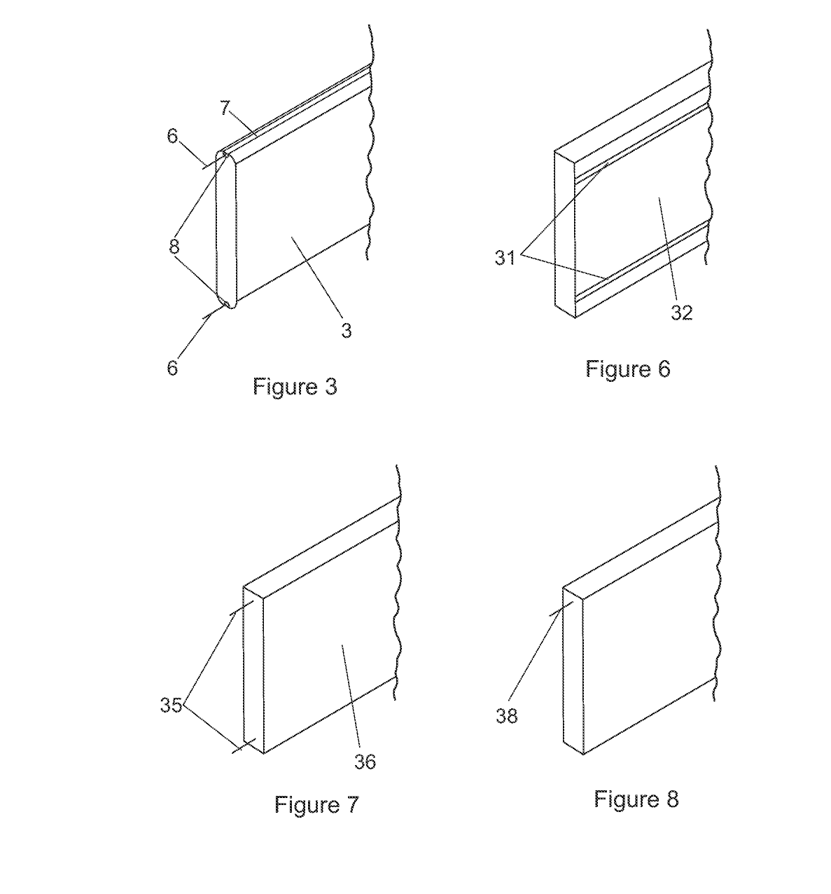

Thus, in the instance of the conductors being located in grooves in the longitudinal edges of the slats in the manner described with reference to FIG. 3, the conductors (6) can be peeled out of the grooves for an appropriate length, as illustrated. The end can then be trimmed off using a suitable saw or the like. Holes can also be drilled through the slats as may be required for fixation using fasteners.

It will also be understood that, at least for the most part, the description applied to electrically conductive conductors applies equally well to optical fibres with appropriate changes to the sensing mechanisms.

The invention therefore provides a simple yet highly effective intruder barrier that is unobtrusive when it is in its operative position; can remain in operation whilst an associated alarm system is in the “on” condition; and interferes with any view only minimally.

1. An intruder barrier comprising:
multiple generally parallel transparent slats acting as burglar bars,
wherein at least some of the transparent slats have associated therewith a conductive path extending at least from a first end region of the slat to a second end region thereof wherein the conductive path is capable of conducting electricity or electromagnetic radiation along the length of the slat, and
wherein the ends of the conductive path are associated with an output to an alarm system that may be configured to trigger an alarm when the conductive characteristic of the slat is terminated by virtue of the slat being at least partially severed, broken, or removed from its operative position.

2. The intruder barrier as claimed in claim 1, wherein the transparent slats are secured to a fixed surrounding frame of an opening window.

3. The intruder barrier as claimed in claim 1, wherein each of the transparent slats has a conductive path associated therewith.

4. The intruder barrier as claimed in claim 1, wherein the conductive paths of the slats are connected in series with each other and with an output to an alarm system.

5. The intruder barrier as claimed in claim 1, wherein the conductive path is an electrically conductive path assuming the form of an electrically conductive wire.

6. The intruder barrier as claimed in claim 1, wherein the conductive path includes a conductor selected from an electrically conductive wire that is optionally located in a groove in a longitudinal edge of the slat, a conductive stripe applied to the surface of the slat, and an optical fiber conductor.

7. The intruder barrier as claimed in claim 1, wherein the conductive path includes a conductor that extends from the first end region of the slat to the second end region of the slat and back again to the first end region.

8. (canceled)

9. (canceled)

10. The intruder barrier as claimed in claim 1, wherein the transparent slats have a conductor applied to the slat so as to extend at least from the first end region to the second end region, and
wherein the conductor is capable of conducting electricity or electromagnetic radiation along its length, the conductor being either embedded within the material of which the slat is made or being secured thereto.

11. (canceled)

12. (canceled)

13. The intruder barrier as claimed in claim 1, further comprising multiple transparent slats interconnected with each other in a laterally collapsible lattice, and
wherein at least some of the transparent slats are provided with the conductive path.

14. (canceled)

15. The intruder barrier as claimed in claim 1, wherein the transparent slats include a conductor that extends away from the slat to form a loop that can be anchored to a frame or fitting secured to a frame.

16. The intruder barrier as claimed in claim 1, further comprising multiple transparent slats interconnected with each other in a laterally collapsible lattice, and
wherein each of the transparent slats are provided with the conductive path.

17. The intruder barrier as claimed in claim 1, further comprising multiple transparent slats interconnected with each other in a laterally collapsible lattice, and
wherein each of the transparent slats are provided with the conductive path, and
the conductive path includes a conductor selected from an electrically conductive wire that is optionally located in a groove in a longitudinal edge of the slat, a conductive stripe applied to the surface of the slat, and an optical fiber conductor.
